(19) United States
(12) Patent Application Publication
(10) Pub. No.: US 2025/0156560 A1
(43) Pub. Date: May 15, 2025

(54) METHOD FOR MANAGING RECORDED IMAGES FOR EACH DRIVER, AND SYSTEM FOR THE SAME

(71) Applicants: HYUNDAI MOTOR COMPANY, SEOUL (KR); KIA CORPORATION, SEOUL (KR)

(72) Inventor: Dong Hyuk JEONG, Hwaseong-si (KR)

(21) Appl. No.: 18/922,370

(22) Filed: Oct. 21, 2024

(30) Foreign Application Priority Data
Nov. 13, 2023 (KR) 10-2023-0156433

(51) Int. Cl. G06F 21/60

(52) U.S. Cl. CPC G06F 21/604

(57) ABSTRACT

The present disclosure relates to a method for managing recorded images for each driver, including distinguishing between at least two drivers, storing recorded images of the vehicle in a specific format, and managing an authority to the recorded images according to the distinguishing, and a system for the same. According to the present disclosure, usability can be improved and privacy secured y storing a built-in cam video separately for each driver, and as the storage space capacity for each driver is distinguished, when old files stored while driving are deleted, only the images in the storage space the driver himself are deleted, thereby preventing existing data other drivers from being deleted unintentionally.

### CROSS-REFERENCE TO RELATED APPLICATIONS

The present application claims priority to Korean Patent Application No. 10-2023-0156433, filed on Nov. 13, 2023, the entire contents of which is incorporated herein for all purposes by this reference.

### TECHNICAL FIELD

The present disclosure relates to a method for managing recorded images for each driver and a system for the same to improve usability and secure privacy by separately storing images or videos for each driver and replaying only images related to the driver himself when multiple drivers use one vehicle.

### BACKGROUND

In general, a black box is a device mainly used in airplanes, and when an airplane crashes or an accident occurs, the black box has been used as clues to identify the cause of the accident by recording the altitude and speed of the airplane, operating status, voice information from the cockpit, communication with the control tower, etc. in order to recognize the situation at that time.

Recently, by applying this technology to vehicles, many black boxes have been installed to record internal and external situations while the vehicle is driving or parked to identify vehicle accidents or theft.

A typical black box has a built-in memory or a removable memory (flash memory, etc.), so the captured video and recorded audio are stored inside the memory. In order to obtain information from a black box installed in a nearby vehicle when an accident or crime occurs, the memory should be separated from the black box and installed in a separate reading device (PC, smartphone, card reader, etc.). Black boxes equipped with a display device are also sold on the market, and in the case of these devices, the screen can be played directly from the black box.

At this time, even though the memory capacity used recently can be replaced with a larger capacity of up to 512G bytes, the memory capacity is limited, so it is necessary to organize data at an appropriate moment.

Moreover, in the case of sharing vehicles, which are used by multiple drivers, there may be cases where each driver organizes data in the memory, which means that another driver can access recorded video while driving.

This runs counter to the expectation that privacy can be protected due to the sense of freedom provided by the independent space of a vehicle. In terms of privacy, if another driver gets into the vehicle regardless of the driver's will, the vehicle can play back the video saved by the previous occupant, exposing personal information, and the video can be deleted, which may result in damage to important evidence.

In addition, when using a memory with a large capacity, the psychological stability of having ample capacity results in a longer data organizing period. As a result, a lot of recorded video is inevitably stored, so it is difficult to search for a desired video or the driver's own recorded video.

In addition, the saved recorded video is stored in the same memory space (micro SD card) regardless of the occupant. As such, when the occupant changes, the recorded video of the previous driver's driving is sequentially deleted and disappears, resulting in the deletion of videos that the previous driver wanted to keep.

### SUMMARY

Various aspects of the present disclosure are directed to solving the above-mentioned problems.

Various aspects of the present disclosure are directed to providing a method for managing recorded images for each driver and a system for the same to improve usability and secure privacy by separately storing images or videos for each driver and replaying only images related to the driver himself when multiple drivers use one vehicle.

According to an embodiment of the present disclosure, there is provided a method of managing recorded images for each driver for vehicle, including: distinguishing between at least two drivers; storing recorded images of the vehicle in a specific format; and assigning an authority to the recorded images according to the distinguishing.

The distinguishing between at least two drivers may further include assigning a unique code to each ignition key.

The ignition key may be one or more of a smart key, a digital key, a card key, or a shared digital key.

The storing of recorded images of the vehicle in the specific format may further include storing indoor and/or outdoor images of the vehicle occurring in a parked state according to a specific format assigned to a driver when the vehicle is turned off and the driver does not leave the vehicle.

The storing of recorded images of the vehicle in the specific format may further include storing indoor and/or outdoor images of the vehicle occurring in a parked state in a public mode when the vehicle is turned off and a driver leaves the vehicle.

The specific format may include a non-transitory memory or/and a folder storage area in a non-transitory memory distinguished according to a unique code assigned to each ignition key held by each of the at least two drivers.

The specific format may include an image storage file naming or/and index distinguished according to a unique code assigned to each ignition key held by each of the at least two drivers.

The authority may be related to one or more of playback, deletion, copying, and external transmission of the recorded images.

The managing of the authority may further include assigning a master authority.

According to an embodiment of the present disclosure, there is provided a system of managing recorded images for each driver for a vehicle, the system comprising: two or more digital keys; a digital key driver authentication module configured to distinguish and authenticate a driver based on the two or more digital keys; a camera image processing module configured to process images acquired from at least one camera observing an interior area and/or an exterior area of the vehicle; a recorded image storage module configured to store recorded images acquired through the camera image processing module under preset conditions or upon request; an audio video navigation (AVN) configured to perform a function according to a request for file management for the recorded images stored in the recorded image storage module; and a management module configured to distinguish between at least two drivers through the digital key driver authentication module, store the recorded images in the recorded image storage module in a specific format for each driver.

The management module may distinguish between the at least two drivers by assigning a unique code to each ignition key.

The ignition key may be one or more of a smart key, a digital key, a card key, or a shared digital key.

The management module may store indoor and/or outdoor images of the vehicle occurring in a parked state according to a specific format assigned to a driver when the vehicle is turned off and the driver does not leave the vehicle.

The management module may store indoor and/or outdoor images of the vehicle occurring in a parked state in a public mode when the vehicle is turned off and a driver leaves the vehicle.

The management module may distinguish a non-transitory memory or/and a folder storage area in a non-transitory memory for the recorded images according to a unique code assigned to each ignition key held by each of the at least two drivers.

The management module may distinguish a naming and/or index of the recorded images according to a unique code assigned to each ignition key held by each of the at least two drivers.

The authority may be related to one or more of playback, deletion, copying, and external transmission of the recorded images.

The management module may allow a driver with master authority to forcibly control other drivers' recorded images files.

According to a method for managing recorded images for each driver and a system for the same according to an embodiment of the present disclosure, usability can be improved and privacy secured y storing a built-in cam video separately for each driver, and as the storage space capacity for each driver is distinguished, when old files stored while driving are deleted, only the images in the storage space the driver himself are deleted, thereby preventing existing data other drivers from being deleted unintentionally.

### BRIEF DESCRIPTION OF THE DRAWINGS

FIG. 1 is an exemplary diagram of a block configuration of a recorded video management system for each driver according to an embodiment of the present disclosure.

FIG. 2 is an example flow diagram for explaining the process of managing a recorded video for each driver according to an embodiment of the present disclosure.

FIG. 3 is an exemplary diagram to explain management techniques for management of each driver.

FIG. 4 is an exemplary diagram to explain management techniques for management of each driver.

FIG. 5 is an exemplary diagram to explain management techniques for management of each driver.

FIG. 6 is an exemplary diagram to explain management techniques for management of each driver.

### DETAILED DESCRIPTION

Since various modifications may be applied to the present disclosure and there may be various embodiments, specific embodiments will be illustrated in the drawings and described in the present disclosure. However, this is not intended to limit the present disclosure to specific embodiments and should be understood to include all changes, equivalents or substitutes included in the spirit and technical scope of the present disclosure.

Suffixes “module” and “part” used herein are only used for the name distinction between components, and should not be interpreted as having a premise of physicochemical classification or separation.

Terms including ordinal numbers such as “first” and “second” may be used to explain various components, but the components are not limited by the terms. The terms may be used only in a name for distinguishing one component from another component, and the sequence between them is recognized by the context of the description, not by the names.

The term “and/or” is used to include all the cases of any combination of the plural items that are subject to the target. For example, “A and/or B” means all three cases of “A”, “B”, “A and B”.

When a component is referred to as “connected” or “linked” to another component, it may be directly connected to or linked to that another component, but it should also be understood that there may be further another component therebetween.

The terms used in the present disclosure are used to explain a particular embodiment, and are not intended to limit the present disclosure. A singular term in the present disclosure includes a plural term unless it is contextually, clearly means a singular form. In the present disclosure, the terms such as “include” or “have” are to specify that there are features, numbers, steps, operations, components or parts described in the present disclosure, or combinations thereof, and It should be understood that the presence or the possibility of addition of numbers, steps, operations, components, part, or combinations thereof are not excluded in advance.

Unless defined differently, all the terms used here, including technical or scientific terms, have the same meaning as commonly understood by those who have normal knowledge in the technical field to which the present disclosure belongs. Terms such as what are commonly used in the dictionary should be interpreted as having the meaning of the context of the relevant technology, and are not interpreted as an ideal or excessively formal meaning unless defined clearly in the present disclosure.

In addition, “unit”, “control unit”, “control device” or “controller” is a term widely used as a name of a device that controls its function, and does not mean a general function unit. For example, a device, which uses one of the above names, may include a communication device which communicates with another controller or sensor for control of the function, a recording medium which may be read by a computer that stores an operating system, a logic command, and input and output information, etc., and one or more processors which perform judgment, operations, and decisions required for the function control.

Further, a processor may include a semiconductor integrated circuit and/or electronic devices that perform at least one or more of comparison, judgment, operation, and decision to achieve a programmed function. For example, the processor may be any one or a combination of a computer, a micro processor, CPU, ASIC, and an electronic circuits (circuitry, logic circuits).

In addition, a recording medium readable by a computer (or briefly called a memory) includes all kinds of storage devices that may be read by a computer system. For example, the storage medium may include at least one of a flash memory, a hard disk type memory, a micro type memory, a card type memory, a secure digital (SD) card, an extream digital (XD) card, a random access memory (RAM), a static RAM, a read-only memory (ROM), a programmable ROM (PROM), an electrically erasable PROM (EEPROM), a magnetic RAM (MRAM), a magnetic disk type memory, and an optical disk type memory.

Such a recording medium may be electrically connected to a processor, and the processor may load and record data from the recording medium. A recording medium and a processor may be integrated or physically separated.

Hereinafter, a method for managing a recorded video for each driver and a system for the same according to the present disclosure will be described with reference to the attached drawings.

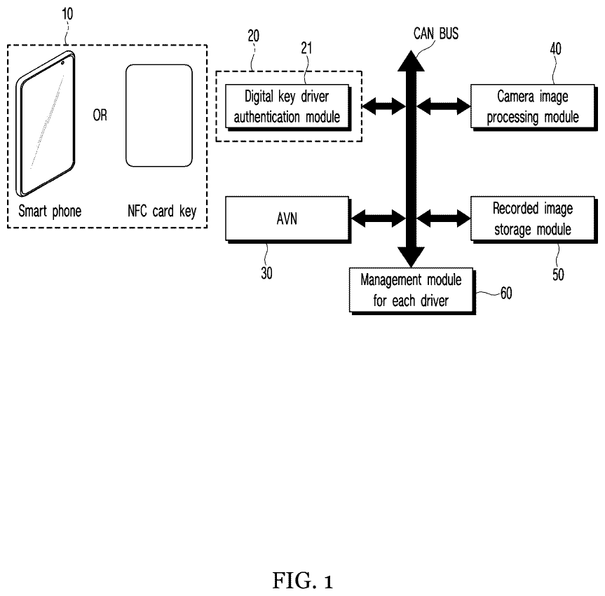

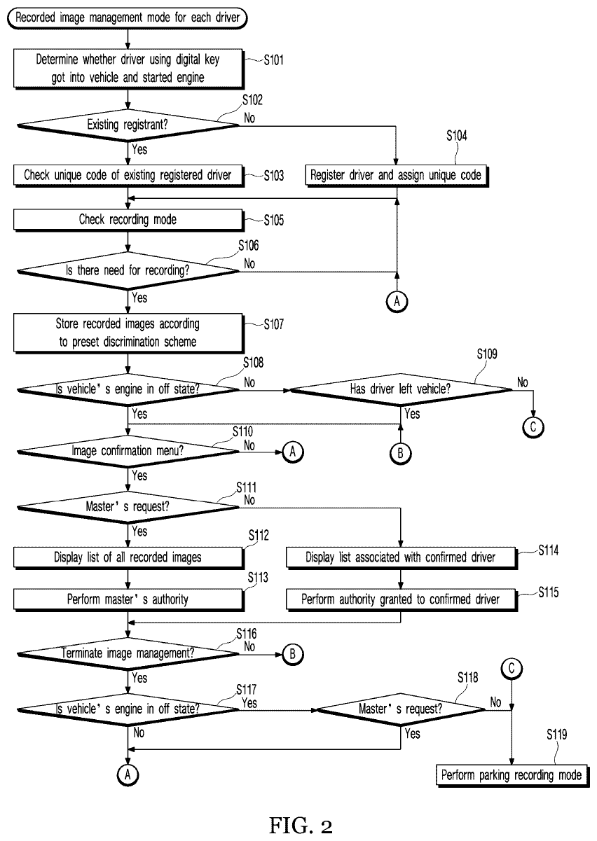

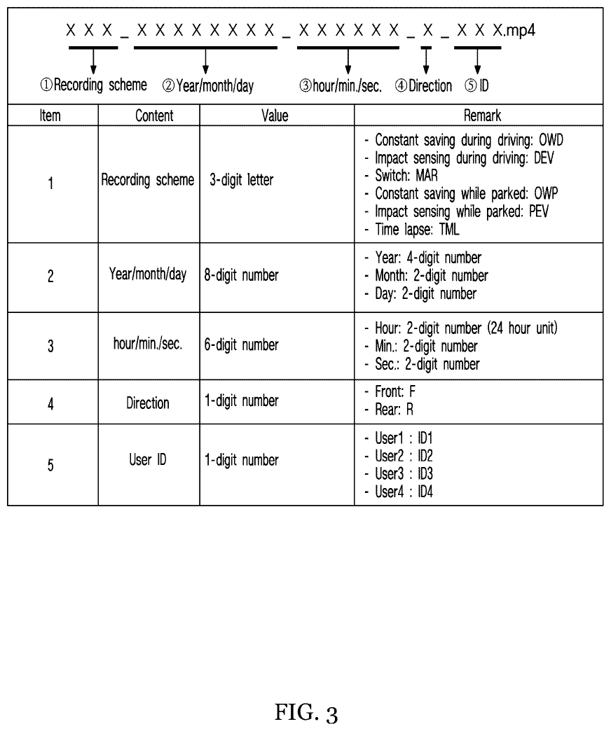

FIG. 1 is an exemplary diagram of a block configuration of a recorded video management system for each driver according to an embodiment of the present disclosure, FIG. 2 is an example flow diagram for explaining the process of managing a recorded video for each driver according to an embodiment of the present disclosure, and FIGS. 3 to 6 are exemplary diagrams to explain management techniques for management of each driver.

As illustrated in FIG. 1, a system for managing recorded images for each driver according to an embodiment of the present disclosure includes a digital key 10 consisting of a smartphone or a NFC card key, a body domain controller (BDC) 20 including a digital key driver authentication module 21, a camera image processing module 40 that processes images acquired from a camera (not shown) that watches the inside and outside of the vehicle, a recorded image storage module 50 that stores images acquired through the camera image processing module 40 under preset conditions (usual event conditions) or upon request, an audio video navigation (AVN) 30 that performs functions according to a request for file management (e.g., playback, copy, removal, external transmission, etc.) for the recorded vidoe files stored in the recorded image storage module 50, and a management module 60 for each driver which distinguishes between at least two drivers through the digital key driver authentication module 21, classifies the interior and exterior images of the vehicle generated by each of the drivers as a specific format to be stored in the recorded image storage module 50, and allows the driver to exercise authority through the AVN 30 only for the recorded video saved by the driver himself or herself.

At this time, the module may be implemented as a memory which stores a program for performing the corresponding function and a processor which executes the program, and the memory of each of the modules may be integrated into one or more memories, and each processor may be integrated into one or more processors.

Referring to the operation of the above-described system for managing recorded images for each driver according to the present disclosure with reference to drawings including FIG. 2, the management module 60 for each driver determines whether the driver using the digital key got into the vehicle and started the engine in step S101.

Afterwards, the process proceeds to step S102 to check whether the driver is an existing registrant. If it is determined that the driver is an existing registered driver, the process proceeds to step S103 to check the preset unique code of the driver.

On the other hand, if it is determined in step S102 that the current occupant is not the existing registrant, the process proceeds to step S104 to register the driver and assign a unique code.

At this time, the unique code is assigned to each ignition key possessed by the drivers, and the ignition key includes one or more of a smart key, a digital key, a card key, or a shared digital key.

Thereafter, when the driver's unique code is confirmed through the process of step S103 or step S104, the process proceeds to step S105 to check the recording mode. In other words, it is determined whether it is continuous recording or event recording.

Depending on the recording mode confirmed in step S105, it is determined whether recording is necessary in step S106. For example, in step S106, if it is assumed that it is a continuous recording mode, it will be determined that there is always a need for recording, and if it is assumed that it is an event recording mode, it will be determined whether an event has occurred.

Therefore, if the need for recording arises in step S106, the process proceeds to step S107 to store the recorded images according to a preset discrimination scheme.

At this time, the above discrimination scheme may be broadly used in four ways, each of which is shown in FIGS. 3 to 6.

Herein, the discrimination scheme shown in FIG. 3 is a scheme called “file naming”. In this scheme, an ID to identify the driver is assigned to the image (video) file name saved in the storage memory and stored sequentially, and when the driver later checks the video for playback, deletion, or copying, only the video corresponding to the driver's ID appears in the list.

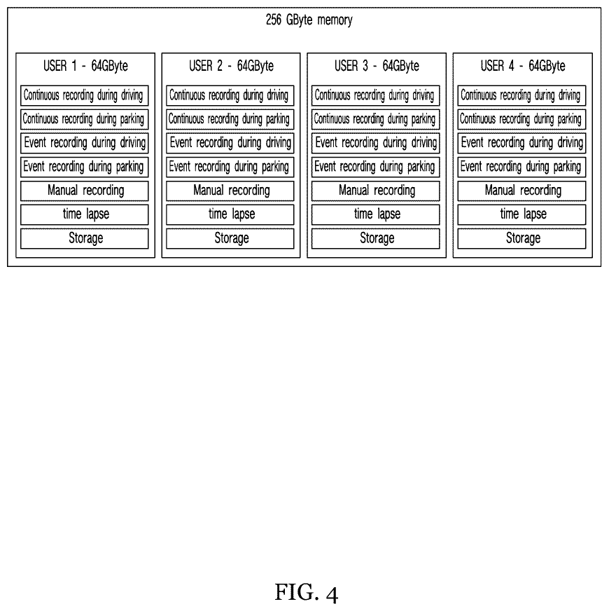

In addition, the discrimination scheme shown in FIG. 4 is called “memory area separation” and is a scheme of dividing the memory by the number of personalized IDs and storing images in the corresponding space when each driver drives. However, when the storage space is full, the size of the space for each user is determined and separated, so the oldest file in the storage space for each type of the user is deleted.

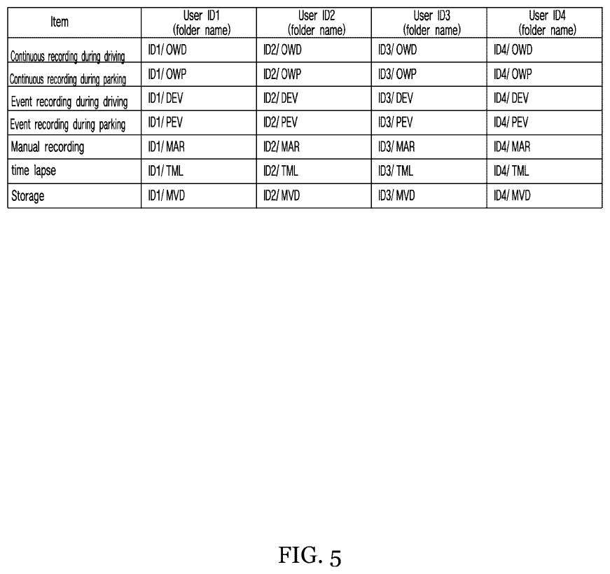

In addition, the discrimination scheme shown in FIG. 5 is called “folder division” and a folder is assigned to each occupant in the storage memory. However, when the storage space is full, the storage space for each type is not changed, and the oldest file in each type of storage space is deleted regardless of the folder.

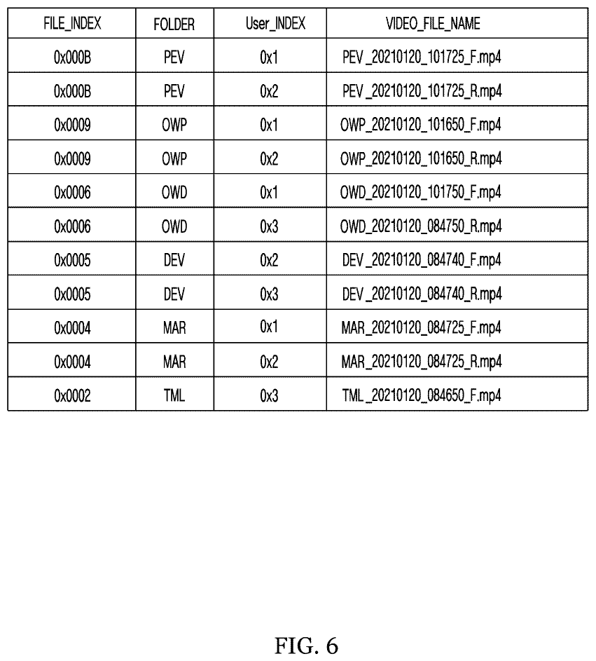

Lastly, the discrimination scheme shown in FIG. 6 is called “index classification”, and manages stored files in a separate database so that each file may be distinguished for each user. However, when the storage space is full, the storage space for each type is not changed, and the oldest file in each type of storage space is deleted regardless of the folder.

However, it should be noted in advance that the discrimination scheme of the present disclosure is not limited to the discrimination schemes of FIGS. 3 to 6 described above.

After storing the recorded images according to the discrimination scheme (one of the discrimination schemes of FIGS. 3 to 6 described above) which is preset through the process of step S107, it is determined whether the vehicle's ignition is in the off state in step S108, and if it is determined that the ignition is in the off state, the process proceeds to step S109 and it is determined whether the driver has left the vehicle through the seating state detection sensor or door lock state detection, etc.

If the vehicle's ignition is not in the off state in step S108 or the driver has not left the vehicle in step S109, it is determined whether a signal requesting image (video) confirmation has been generated by the driver through the AVN 30 in step S110.

If it is determined that an image confirmation request has occurred in step S110, the process proceeds to step S111 to determine whether the request is a master request. In other words, one of the above-described ignition keys is selected as the master key, and the driver who uses the ignition key selected as the master key becomes the master.

If it is determined that it is a master's request in step S111, the process proceeds to step S112 and all recorded images assigned to different drivers may be viewed in a list without distinction.

Thereafter, the master's authority is exercised through the process of step S113. At this time, the master's authority means one or more of the following: playback, deletion, copying, or external transmission of all recorded images being viewed.

On the other hand, if it is determined in step S111 that it is not the master's request, the process proceeds to step S114 to view the list of images (videos) (distinguished images) associated with the confirmed driver.

At this time, the driver's authority means one or more of the following: playback or deletion, copying, or external transmission only of recorded images (videos) classified in relation to the driver himself.

Thereafter, in step S116, it is determined whether a request was made to terminate the image management mode after the process of step S113 or step S115. If it is determined that the image management mode has been terminated, the process proceeds to step S117. If it is determined that it has not been terminated, the process proceeds to step S110 and the above-mentioned process is repeated.

In step S117, it is determined whether the vehicle's ignition is in the off state, and if it is determined that the ignition is in the off state, the process proceeds to step S118 to determine whether the driver has left the vehicle through a seating state detection sensor or door lock state detection.

If the vehicle's ignition is not in the off state in step S117 or the driver has not left the vehicle in step S118, the process proceeds to step S105 and the above-described process is performed again.

On the other hand, if it is determined in step S109 or step S118 that the driver has left the vehicle, the process proceeds to step S119 to perform parking recording mode because the vehicle is in parking mode.

At this time, the recorded images in parking mode may be set to be viewed by any driver with a registered ignition key, regardless of driver.

Therefore, when multiple drivers use one vehicle, images for each driver may be stored separately, and only images related to the driver himself may be played, thereby improving usability and securing privacy.

In the above, preferred embodiments of the present disclosure have been illustrated and described, but the present disclosure is not limited to the specific embodiments described above, and various modifications and implementations can be made by those skilled in the art without departing from the gist of the present disclosure as claimed in the patent claims. And these modified implementations should not be understood individually from the technical idea or perspective of the present disclosure.

What is claimed is:

1. A method of managing recorded images for each driver for vehicle, the method comprising:
distinguishing between at least two drivers;
storing recorded images of the vehicle in a specific format; and
assigning an authority to the recorded images according to the distinguishing.

2. The method of claim 1, wherein the distinguishing between at least two drivers comprises assigning a unique code to each ignition key.

3. The method of claim 2, wherein the ignition key is one or more of a smart key, a digital key, a card key, and a shared digital key.

4. The method of claim 1, wherein the storing of recorded images of the vehicle in a specific format comprises storing indoor images of the vehicle in a parked state, outdoor images of the vehicle in a parked state, or both, according to a specific format assigned to a driver when the vehicle is turned off and the driver does not leave the vehicle.

5. The method of claim 1, wherein the storing of recorded images of the vehicle in a specific format comprises storing indoor images of the vehicle in a parked state, outdoor images of the vehicle in a parked state, or both, in a public mode when the vehicle is turned off and a driver leaves the vehicle.

6. The method of claim 1, wherein the specific format includes a non-transitory memory or a folder storage area in a non-transitory memory distinguished according to a unique code assigned to each ignition key held by each of the at least two drivers.

7. The method of claim 1, wherein the specific format includes an image storage file naming, an index, or both, distinguished according to a unique code assigned to each ignition key held by each of the at least two drivers.

8. The method of claim 1, wherein the authority is related to one or more of playback, deletion, copying, and external transmission of the recorded images.

9. The method of claim 1, wherein the managing of the authority includes assigning a master authority.

10. A system of managing recorded images for each driver for a vehicle, the system comprising:
two or more digital keys;
a digital key driver authentication module configured to distinguish and authenticate a driver based on the two or more digital keys;
a camera image processing module configured to process images acquired from at least one camera observing an interior area or the vehicle, an exterior area of the vehicle, or both;
a recorded image storage module configured to store recorded images acquired through the camera image processing module under preset conditions or upon request;
an audio video navigation (AVN) configured to perform a function according to a request for file management for the recorded images stored in the recorded image storage module; and
a management module configured to distinguish between at least two drivers through the digital key driver authentication module, store the recorded images in the recorded image storage module in a specific format for each driver.

11. The system of claim 10, wherein the management module distinguishes between the at least two drivers by assigning a unique code to each ignition key.

12. The system of claim 11, wherein the ignition key is one or more of a smart key, a digital key, a card key, and a shared digital key.

13. The system of claim 10, wherein the management module stores indoor and/or outdoor images of the vehicle occurring in a parked state according to a specific format assigned to a driver when the vehicle is turned off and the driver does not leave the vehicle.

14. The system of claim 10, wherein the management module stores indoor and/or outdoor images of the vehicle occurring in a parked state in a public mode when the vehicle is turned off and a driver leaves the vehicle.

15. The system of claim 10, wherein the management module distinguishes a non-transitory memory or a folder storage area in a non-transitory memory for the recorded images according to a unique code assigned to each ignition key held by each of the at least two drivers.

16. The system of claim 10, wherein the management module distinguishes a naming or index of the recorded images according to a unique code assigned to each ignition key held by each of the at least two drivers.

17. The system of claim 10, wherein the authority is related to one or more of playback, deletion, copying, and external transmission of the recorded images.

18. The system of claim 10, wherein the management module allows a driver with a master authority to forcibly control other drivers' recorded images.
